(19) United States
(12) Patent Application Publication
(10) Pub. No.: US 2016/0154138 A1
(43) Pub. Date: Jun. 2, 2016

(54) Speed Bump Bomb Detector for Bombs in Vehicles

(71) Applicant: CALSEC CALIFORNIA SCIENCE & ENGINEERING CORPORATION, Irvine, CA (US)

(72) Inventors: Alexander Suvakovic, Irvine, CA (US); Bogdan C. Maglich, Irvine, CA (US)

(21) Appl. No.: 14/906,906

(22) PCT Filed: Jul. 22, 2014
(86) PCT No.: PCT/US14/47567

§ 371 Date: Jan. 22, 2016

Related U.S. Application Data
(60) Provisional application No. 61/857,641, filed on Jul. 23, 2013.

(51) Int. Cl. G01V 5/00

(52) U.S. Cl. CPC G01V 5/0016

(57) ABSTRACT

The invention provides a method and apparatus for detecting the presence of explosives in the trunk or rear area of a vehicle using neutron invasion of that vehicle area and resulting gamma ray sensing resulting from the reaction of the neutrons, typically fast neutrons, with explosives therein enhanced by the interaction of the neutrons with fuel, the neutron generation and gamma ray sensing being in equipment located in speed bumps or recessed below the road surface.

### CROSS REFERENCE TO RELATED APPLICATIONS

This application claims the benefit under 35 U.S.C. §119(e) of U.S. Provisional Patent Application No. 61/857,641, filed Jul. 23, 2013, the disclosure of which is incorporated by reference herein.

### FIELD OF THE INVENTION

The present invention relates to noninvasive detection of explosives concealed in automobiles.

### BACKGROUND OF THE INVENTION

Detection of explosives concealed in vehicles a.k.a. Carbombs, are a top national security priority issue in the War Against Terrorism. Carbombs are a present danger and increasing menace to peace and stability in Europe, Middle East and Asia. Large explosive assemblies of 50 to 1000 lbs are 98% of the time placed in automobile's trunks and remotely exploded by a suicidal driver while passing in front of the buildings and facilities (Iraq, Afghanistan, Indonesia). In another modus operandi, Carbombs are placed in parked unattended cars and remotely triggered by mobile telephones when the target car or individual is passing by (Spain, Lebanon, Israel, Russia, S. Arabia). Detection of an explosive is a 2 step process: (1) primary or anomaly detection, i.e. the detection of “possible” explosive and (2) secondary or confirmation detection, which conclusively determines by a close examination (until now always manual) whether the anomalous object contains explosive or is a “false alarm.”

Today, counter measures to Carbombs are a combination of noninvasive and invasive inspection of the stopped cars, emptied of passengers at the entry checkpoints. Noninvasive checkpoint methods are under the car imagers of the chassis, seeking anomalous shapes, coupled to visual inspection of the car through windows. This is followed by invasive manual inspections and dog sniffing of the vehicle and trunk interior. In some installations X ray inspection is performed. All currently used X-ray based explosive detection systems (EDS) are chemically blind. They can image the locations, shapes and density of hidden objects but have no ability to chemically determine whether they are explosives or not and hence require manual inspection. Without X ray inspection, a minimum average inspection time per vehicle is 3 minutes, thus resulting in a throughput of 20 cars/hour. The security agencies' requirement is 10 times greater, i.e. at least 100 vehicles/hour. Prior systems employ Atometry principles as shown in Appendix A.

### BRIEF SUMMARY OF THE INVENTION

The method and apparatus of this invention is projected to increase the throughput rate to 440 vehicles/hour.

Specifically, this patent application is directed to major improvements of the SCI process (1) by concealing the detector system under speed bump, (2) portability of the system with easy assembly and disassembly features at permanent and improvised checkpoints, and (3) greatly reduced vehicle inspection time over that by SCI resulting in (4) a significantly increased vehicle throughput; the latter, (3-4), are achieved by using a radically improved method and technique of Fast Neutron Atometry, published in “Birth of Atometry” by B. Maglich noted above.

This is accomplished by a combined action of (a) Differential Neutron Elementry as primary detector and (b) Double Neutron Atometry as a confirmation sensor. The latter is a simultaneous 2-beam (thermal & fast neutron) illumination of the object in the trunk by making fast neutron passage through the gasoline tank.

### DESCRIPTION OF THE DRAWINGS

FIG. 1 illustrates the used SIEGMA 3E3 atometer robotically carried to investigate a briefcase for explosives;

FIG. 2 is a graph comparing gamma ray spectra of fast neutron explosive systems, ANCORE, for pulsed neutrons versus low resolution gamma detectors with measurement by non-pulsed, solid state gamma detector atometer;

FIG. 3 shows an atometer housed in the briefcase of FIG. 2 and showing the components of the atometer, disguised in the suitcase, comprising an accelerator (neutron generator), germanium detector, and processing electronics;

FIG. 4 shows a screen display for the operator to view the results of the atometer in use;

FIG. 5 pictorially illustrates the use of the atometer device adapted for use in a speed bump according to the invention;

FIG. 6 diagrammatically illustrates the components of the atometer from the suitcase as employed in a speed bump detector;

FIG. 7 is a side view illustrating the components of the atometer of the invention in a speed bump;

FIG. 8 diagrammatically illustrates the components of the atometer from the suitcase as employed in a speed bump according to the invention;

FIG. 9A illustrates a vehicle approaching a pair of speed bumps, including the atometer according to the invention;

FIG. 9B illustrates the vehicle beginning to pass over the speed bumps;

FIG. 10 pictorially illustrates a portable rolling speed bump according to the invention allowing it to be positioned under a vehicle trunk to detect explosives within the vehicle trunk;

FIG. 11 is a diagrammatic view showing radiation paths for detecting explosives in the trunk of the vehicle between two speed bumps.

FIG. 12 illustrates a portable device for displaying the results of the explosive exploration.

FIG. 13 illustrates an embodiment of the invention wherein the explosive detection equipment is installed below a road surface;

FIG. 14 illustrates the use of the embodiment of FIG. 13 for a vehicle passing there above;

FIG. 15 illustrates in cross-section the detection device of the invention installed below a roadway surface.

### DETAILED DESCRIPTION OF THE INVENTION

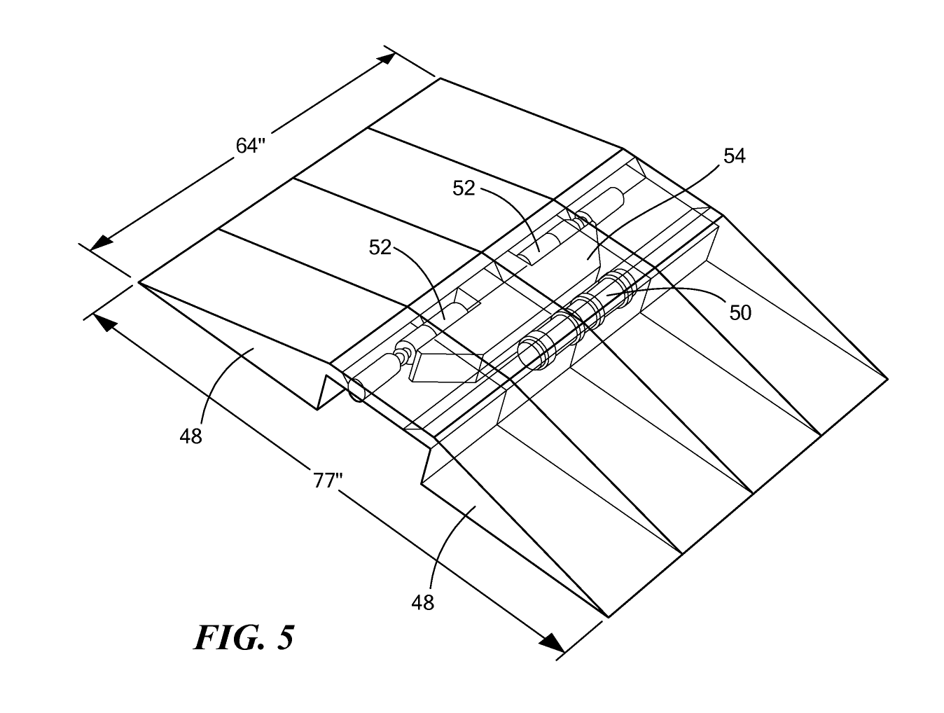

Since 98% of car bombs are concealed in trunks, the invention is described for an embodiment of Carbomb detection in terms of detection of a bomb, typically of 100 lbs or more, in the trunk of an automobile. It is sketched in FIGS. 5-11.

Atometry is stoichiometry by means of neutrons. It is a non-intrusive diagnostic process that provides stoichiometry of unknown substances by irradiating them with fast neutrons of femtometer (10⁻¹⁵ m) wave-length. The technique deciphers, in real time empirical chemical formulas of unknown objects, CₐN_{b}O_{c}, where a, b, and c are the atomic proportions of carbon, nitrogen, and oxygen, with a 97.5% (2σ) statistical probability.

Military explosives consist of 4 elements: H, C, N and O. E.g. stoichiometry of TNT is C₇N₃O₆H₅. For RDX, used in plastic bombs, it is C₆N₆O₆H₆. Non-military explosives, e.g. homemade terrorist bombs, are also detectable by atometry although they contain other elements, notably chlorine. The presence of nitrogen, often incorrectly referred to as to ‘explosive signature’ is only a “possible explosive indicator”. 1 m3 of air contains nearly a kilogram of N₂. Qualitatively detecting the mere presence of one or more elements of the explosive does not make an explosive detector.

Since first neutron count excites H, the task of atometry is to obtain, in a shortest time possible, quantitative atomic ratio of the 3 elements i.e. the subscripts a, b, c in CₐN_{b}O_{c}, to an accuracy sufficient to discriminate explosives from 1,000-odd innocuous substances also containing C, N and O. The atometry algorithm calculates the relative number of atoms of C, N and O and plots them onto a 3-dimensional view in which each C:N:O ratio is representing by a dot.

Atometry is achieved by quantitative measurement of high-resolution γ spectra emitted from inelastic scattering of fast neutrons. Neutrons of E=5-50 MeV, have a DeBroglie wave-length of the order of femtometer and so collide directly with the nuclei of C, N and O, unaffected by their chemical bonds or aggregate state. They produce characteristic γ's from each of the 3 elements, γ energies being 4.4, 5.1 and 6.1 MeV, respectively.

Neutrons are produced by a DC (non-pulsed) beam of deuterons in the reaction: d+t→α+n+17.8 MeV (1). Next, they interact with nuclei of elements X: n+X→X*→X+γ+n′ (2), where γ's are emitted by the transition between energy levels of X, the energy spectra of which are element-specific.

The irradiation time is decided upon by the algorithm in each case until the statistical error on the atomic proportions (a, b, c) reaches 2σ, which corresponds to 95% confidence level. Depending on target mass, this takes anywhere from 5 sec. to 5 min. If 95% confidence is not reached in 5 minutes, the result is inconclusive, and re-measurement of new conditions (distance, intensity, etc.) is attempted by the operator.

The present invention adapts known technology to the use in a speed bump for automobiles to pass over, while the technology is applied to generate neutron exploration of trunk contents while the vehicle moves over the bump.

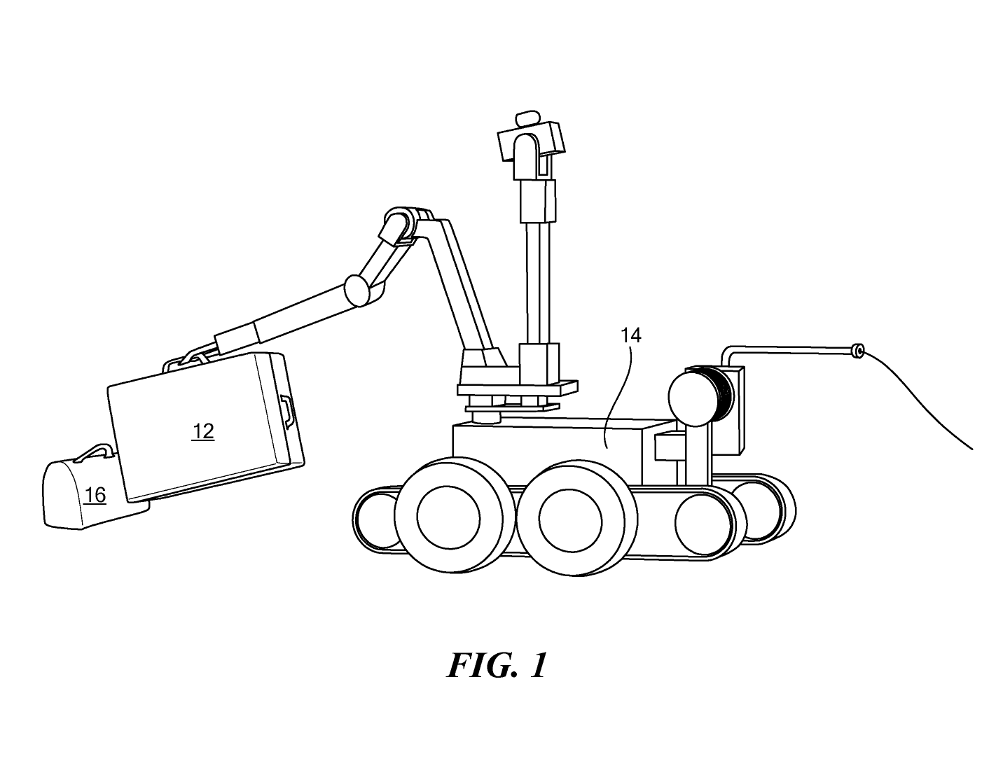

FIG. 1 illustrates a suitcase 12 containing exploratory and sensing electronics as described below and safely carried without human intervention on a mobile robot 14 to sense the contents of a briefcase 16. The briefcase 12 in this environment uses a SIEGMA 3E3 sensing apparatus as described below to pass neutrons into the briefcase 16 and sense gamma rays from which the presence of explosives can be determined using known technology.

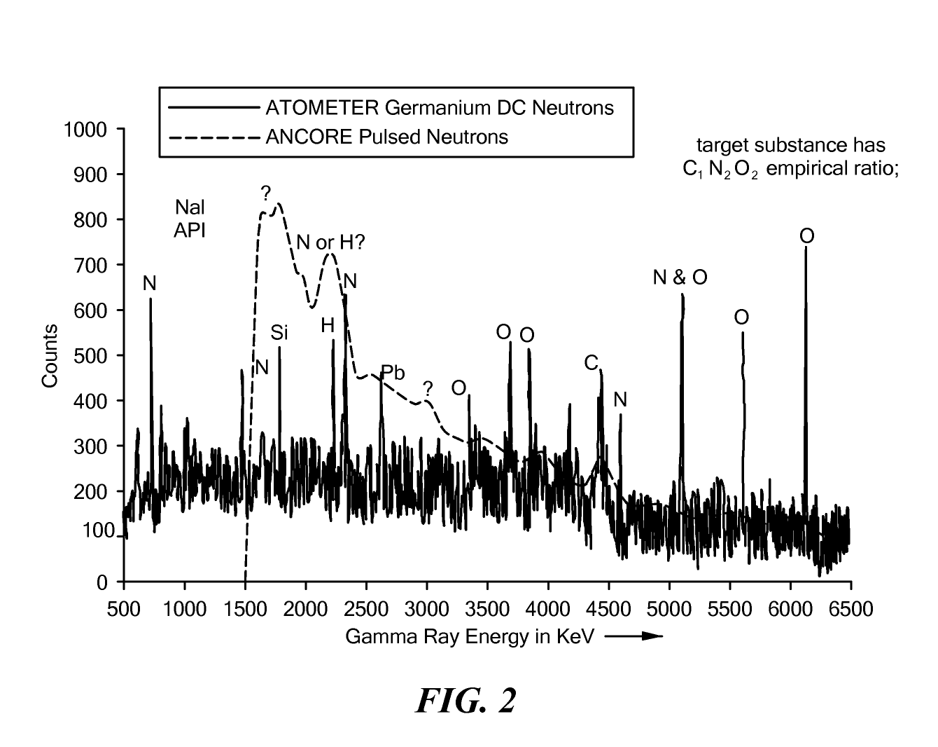

The present invention uses a known ATOMETER gamma ray detector system as opposed to other systems such as the ANCORE system. The latter uses pulsed neutron while the former is non-pulsed. The latter system response is illustrated in the slightly curved line of FIG. 2, while the ATOMETER output is illustrated in the sharply hashed line. The detection of the relevant chemicals for explosives is illustrated by sharp spikes in the relative explosive chemicals illustrating graphically the high sensitivity for explosive detection in the technology used in the present invention.

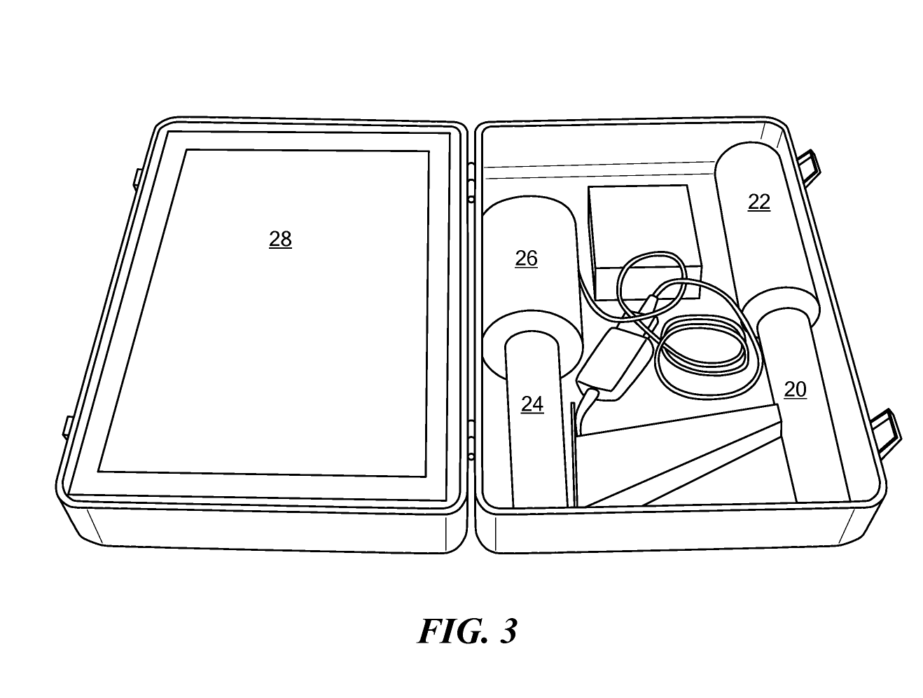

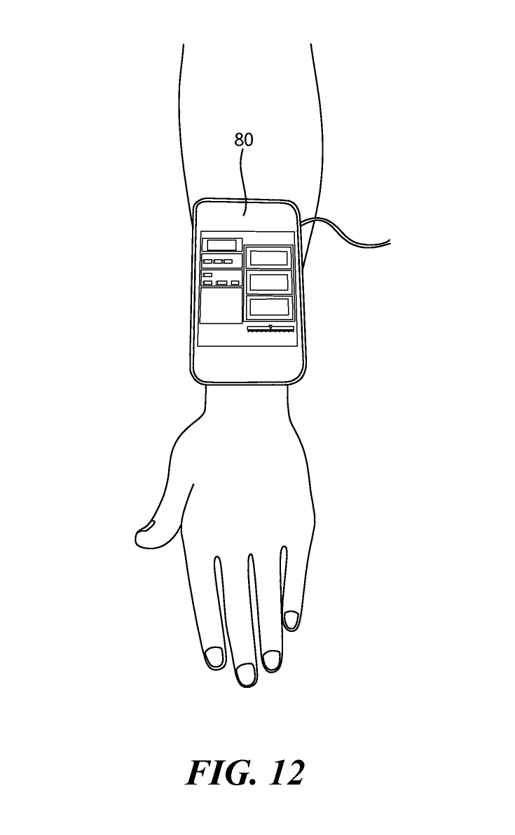

The known technology described above is illustrated in the contents of the suitcase 12 as open in the view of FIG. 3. Neutrons are emitted from a source 20 caused by particles accelerated from a particle accelerator 22. The response of explosives is sensed by a Germainium GammaRay detector 24, which is made operationally cold by a cryo-cooler 26. To cause the elements described above to the right in the suitcase view of FIG. 3 to operate, known electronics 28 are provided in the left portion of the suitcase of FIG. 3. The electronics 28 provide by cable or wireless means an output to a known display terminal 30 illustrated in the 4 which may be stationary or in a tablet or cell phone device 80 (FIG. 12).

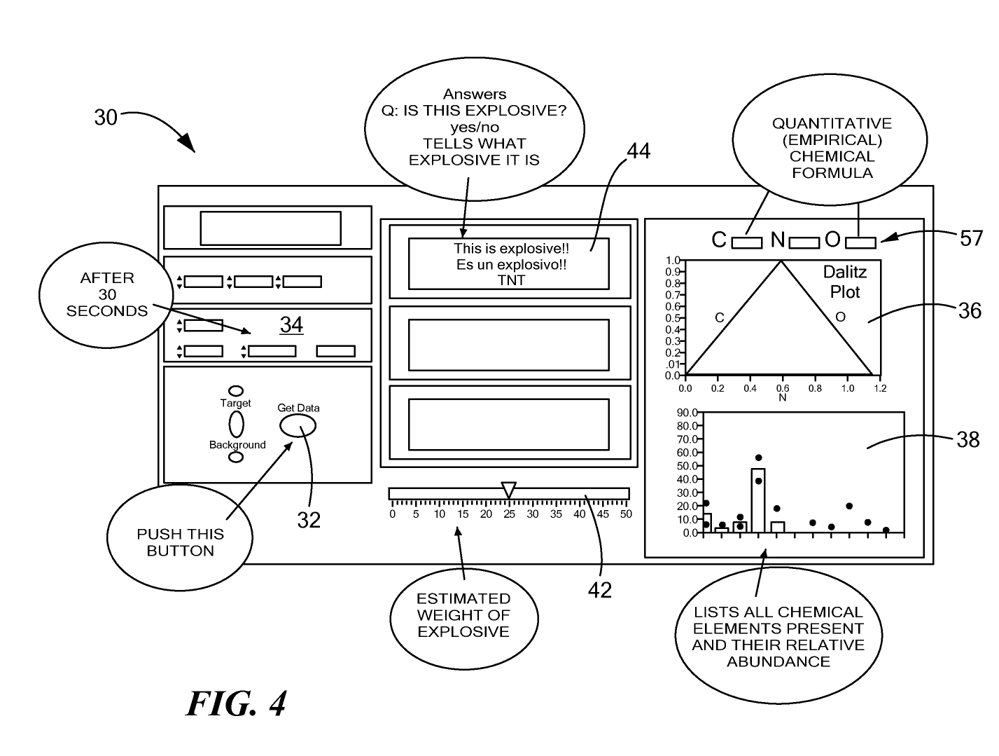

FIG. 4 illustrates the display panel as known in the art for use with the ATOMETER Suitcase described above. The system is activated by a button 32 which may enable sensing of any detected gamma rays at the time of activation for the contents of the suitcase continuously in operation or may at that same time start the activation and operation of the suitcase contents. In either case, sensing continues for a period of time, typically 30 seconds as displayed on a panel 34. The known sensing electronics provides in a display 36 an estimate of the amount of essential chemicals sensed from Gamma ray radiation, particularly carbon, nitrogen and oxygen and in labeled windows 37. A further display 38 may provide a list and percentage of concentration of all chemicals sensed. The known sensing electronics of FIG. 4 may also provide an estimate of the weight of the explosives in display 42, along with a go/no-go or yes/no estimate of the presence of explosives in display 44.

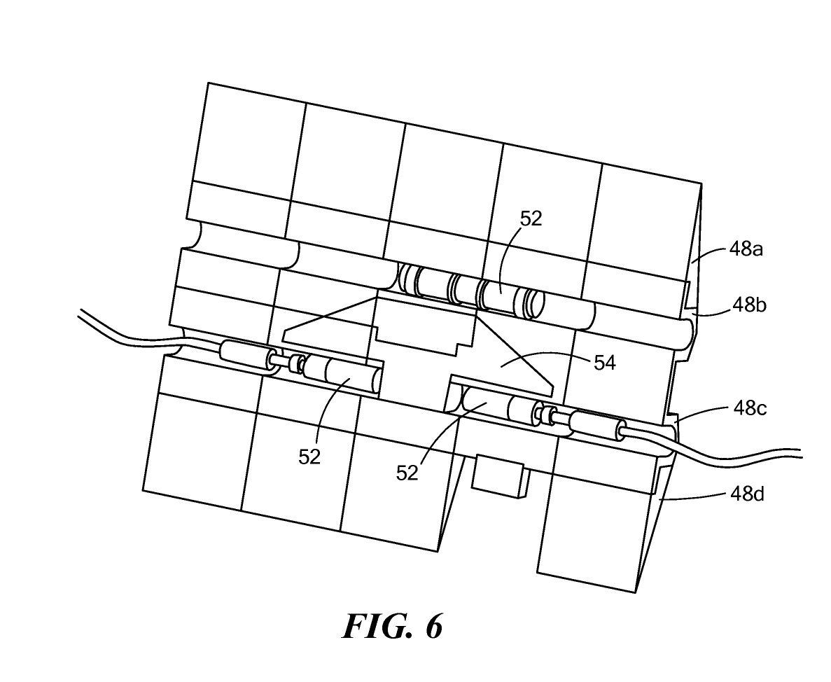

A preferred embodiment of the speed bump Carbomb detector of this invention, known as Advanced Explosive Identifier and Recognizer, AXIOR-700 series, is shown in FIGS. 5 and 6. Commercially produced standard speed bump (48) made of composite material, consisting of 4 segments (48a, b, c and d), holds commercially produced neutron generator (50) manufactured by Thermo Fischer Scientific, Model MP 320, emitting neutrons with a fluence of 5×10⁷ and 2 germanium gamma detectors (52), high resolution HPGD (High Purity Germanium Detector) Model GMX50P4-83 n-type, manufactured by ORTEC, with a gamma energy resolution of 0.2%. A shield 54 separates the emitter and sensor to prevent error signals.

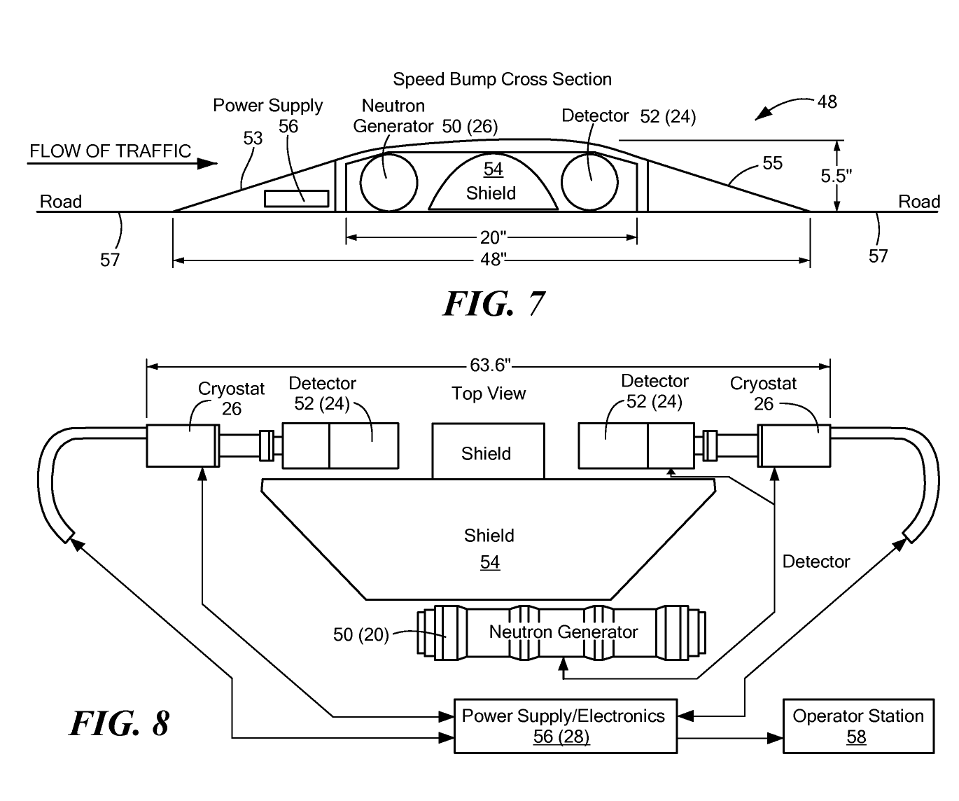

FIGS. 7 and 8 show elevation and top views of the speed bump having the system of the invention, respectively.

FIG. 7 illustrates in elevation and sectional view the speed bump of the invention having an approach ramp 53 and an exit at ramp 55. The power supply 56, corresponding to electronics 28 previously presented, is typically under the approach ramp 53. The neutron generator 50, corresponding to generator 26 previously described, is located directly after the approach ramp 53 separated from the detectors 52 corresponding to detectors 24 previously discussed by the shield 54. The speed bump 48 sits on a road surface 57.

FIG. 8 illustrates diagrammatically the elements of the electronics and generators and detectors of the invention used in the speed bump of FIG. 7. The electronics 56 control the cryostat's 26, activates the neutron generator 50 (20) and receives signals from the detectors 52 (24). The electronics 50 supplies signals to the operator console 58 illustrated in FIG. 4.

Typically, test runs of as many as 100 will be made with vehicles both having and not having explosive content of various weights in order for the electronics 56 to be calibrated so that the detection of the three main chemicals, H, C and O can be related to the presence or absence of an explosive and an estimate of the size of the explosive device.

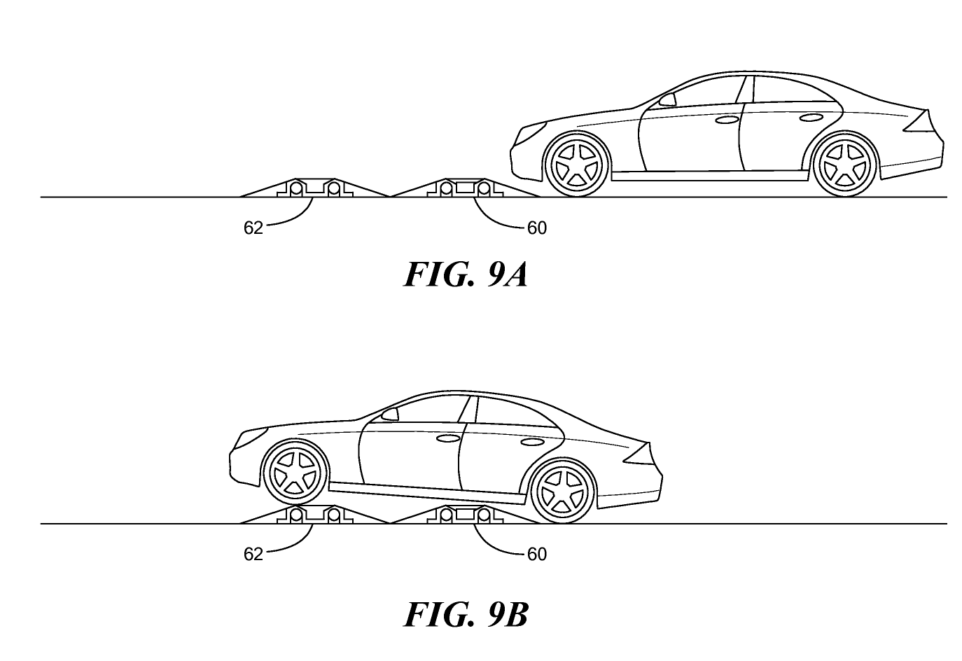

FIGS. 9A, 9B and 11 illustrate the bomb inspection procedure in 3 sequences. Starting in FIG. 9A, as the car approaches a set of two speed bumps 60 and 62, the front wheels traverse both bumps 60 and 62 in FIG. 9B. When the car stops in the valley between the two speed bump structures in FIG. 11, the rear one being active and front a dummy, measurements are made.

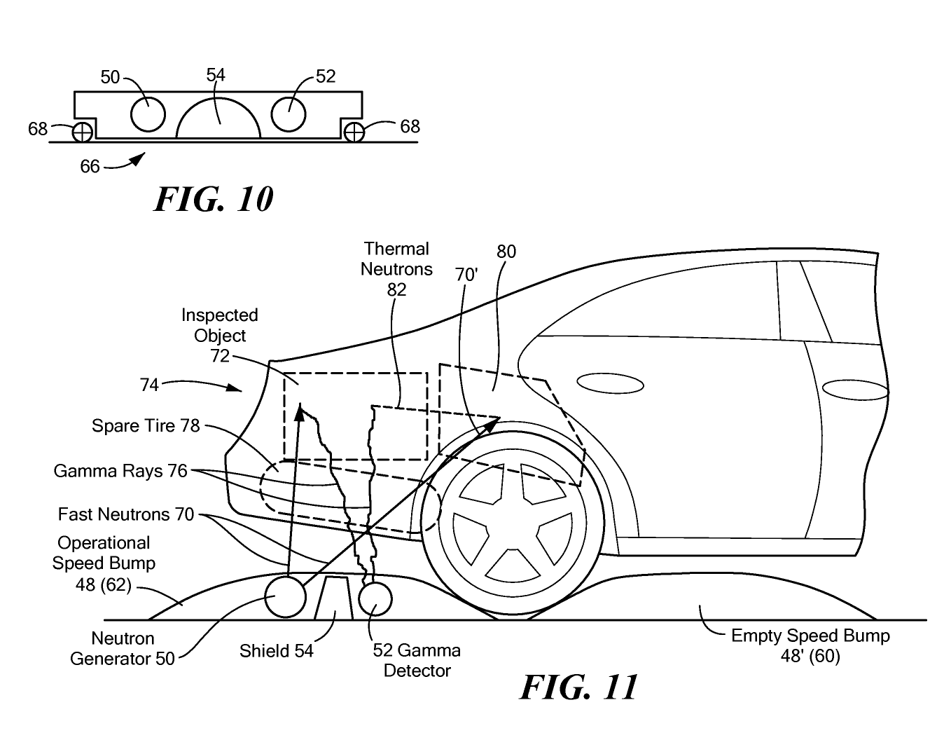

In an alternative embodiment of FIG. 10 designed to check the standing or parked vehicles, be it attended or unattended, an active (rear) section 66 of the speed bump is used alone, without the dummy one, and it is installed on wheels 68 so that it can slide under the car trunk.

The trunk and car body inspection procedure below is the same for both embodiments.

FIG. 11 shows the bomb detection procedure. Fast neutrons 70 emitted from the generator 50 enter an investigated object 72 in the trunk 74 and produce gamma rays 76 which are detected in High Purity Germanium Detector, HPGD, 52. Some fast neutrons 70 pass through spare tire 78 and enter fuel tank 80, where the are converted into thermal neutrons 82. The thermal neutrons get captured in the nitrogen nucleus of the investigated object 72 and emit gamma rays 76′ which are also detected by HPGD 52.

To reduce the throughput time, the invention introduces a two-step Carbomb inspection process, as follows.

Step 1: Differential elementry. As soon as the vehicle is stopped in the position, in FIG. 11, neutron generator 50 illuminates the entire rear end of the vehicle with fast neutrons. Electronics 56 and 58 look for one chemical element difference in the gamma ray spectrum between the average normal car chemical content and that being examined. This invention takes advantage of the property of the explosives that they have more nitrogen (N), than common substances. Hence, detection of greater than normal N content is a pre-signature of an explosive. In this invention the processing in electronics 56 and 58 look first for anomalously high N count above the background N count, averaged over 100 other samples of explosion free vehicles, but not statistically significant more than by 1σ. This is referred to as “differential elementry” and the anomalous N count is pre-alarm which causes the vehicle to stop or be stopped by an attendant. The Differential Elementry process lasts 7 sec.

Step 2: Dual fast -and- thermal neutron atometry. Only if a pre-alarm occurs in the processing above, the algorithm continues a complete 3-element atometry process to further decipher the gamma rays according to the technology above to determine if it is explosive. Using only the fast neutrons, this process takes 16 seconds. To further shorten the analysis time, this invention increases by 33% the number of “useful” neutrons. This is done by the passage of fast neutrons through the fuel tank at the trunk which results in thermalization of approximately 33% of the neutrons. Thermal neutrons are captured by nitrogen (N) in any explosive present which, in turn, emits gamma rays of 10.8 MeV. Net result is that about 30% more neutrons produce nitrogen based gamma rays which, in return, reduce atometry time to 11 sec. from 16 sec.

Combining Step 1 and Step 2, there will be times needing only exposure of 7 seconds and those needing exposures of 18 (7+11) seconds. The latter are those with pre-alarm. Assuming a worst case scenario that 1 of 10 cars trips pre-alarm and has to be subjected to full atometry check, the invention obtains 8.2 seconds per vehicle on average, which corresponds to a thruput of 440 cars per hour.

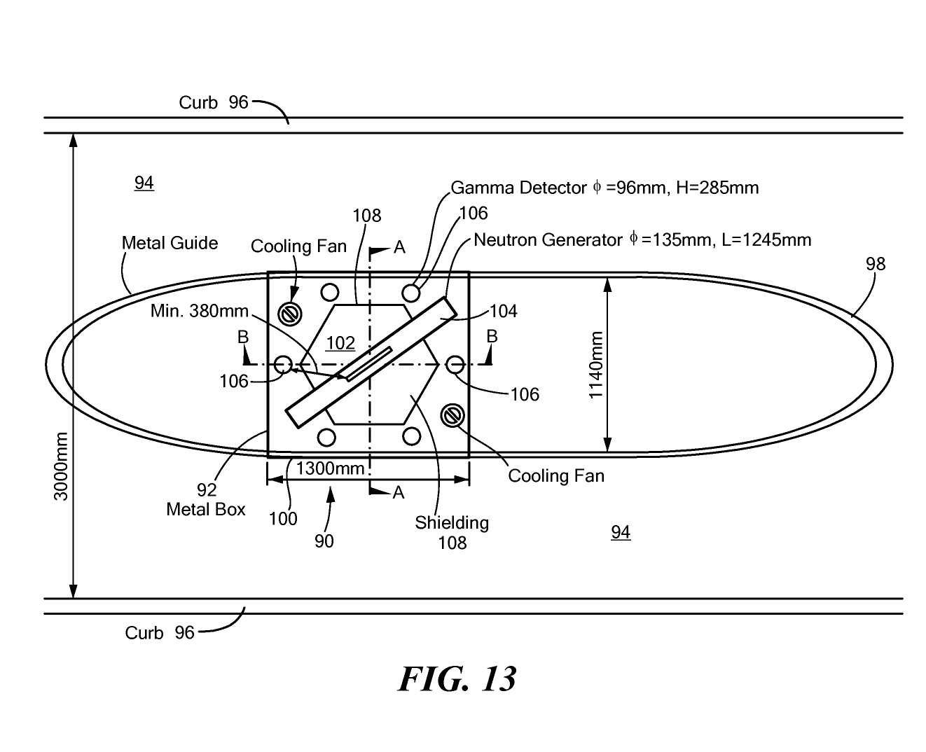

In a further embodiment of the invention illustrated in FIG. 13, the detection device of the invention 90 is installed in a box 92 below a surface 94 bounded by curbs 96, through which a vehicle will pass for trunk inspection for the presence of an explosive. A typically metal guide 98 protrudes slightly above the road surface 94 to ensure vehicles passing over the detection system 90 will have the trunk properly positioned.

The box 92 and contents are positioned entirely below the road surface and have above them an aluminum plate 100 with or without apertures to permit neutron and Gamma ray passage. The box 92 contains a neutron generator 102 within container 104. Surrounding the neutron generator 102 are six gamma ray detectors 106 arranged hexagonally around the generator 102 and at a minimum distance, typically about 15 inches, for interference avoidance. Shielding means 108 may be provided as desired.

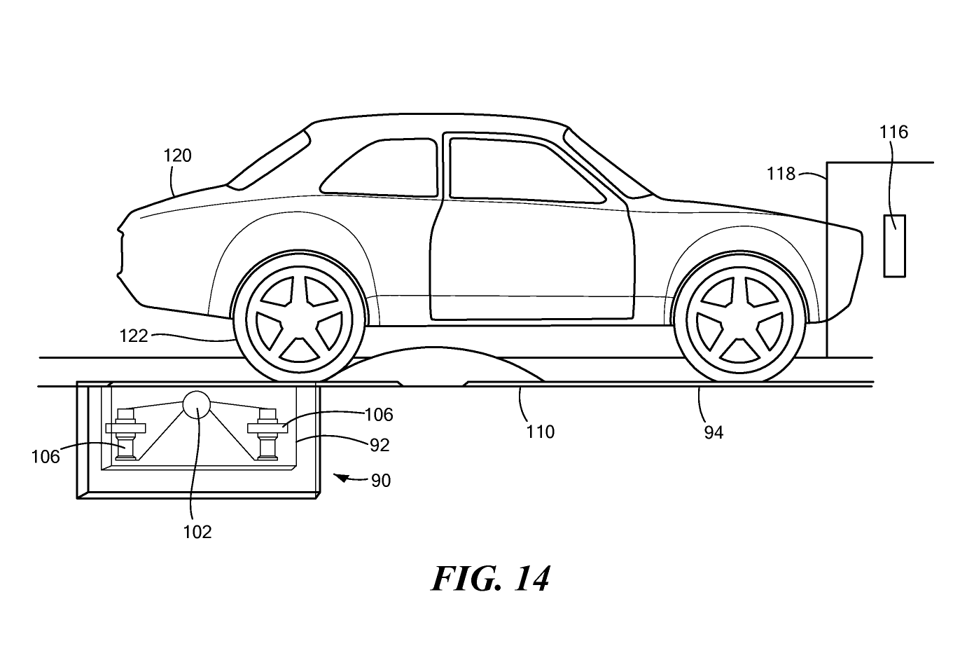

FIG. 14 illustrates the subsurface detection device of the invention 90 in box 92 with neutron emitter 102 and gamma ray detectors 106 below the road surface 94. In order to position the vehicle 120 for appropriate trunk inspection by the device 90, a speed bump 110 may be provided to stop the rear wheels 122 appropriately. Alternatively, a barrier 116 may be provided operated by a controller 118 to cause the barrier 116 to raise or lower to a position stopping the vehicle from proceeding for the period of time needed for trunk inspection by the device 90.

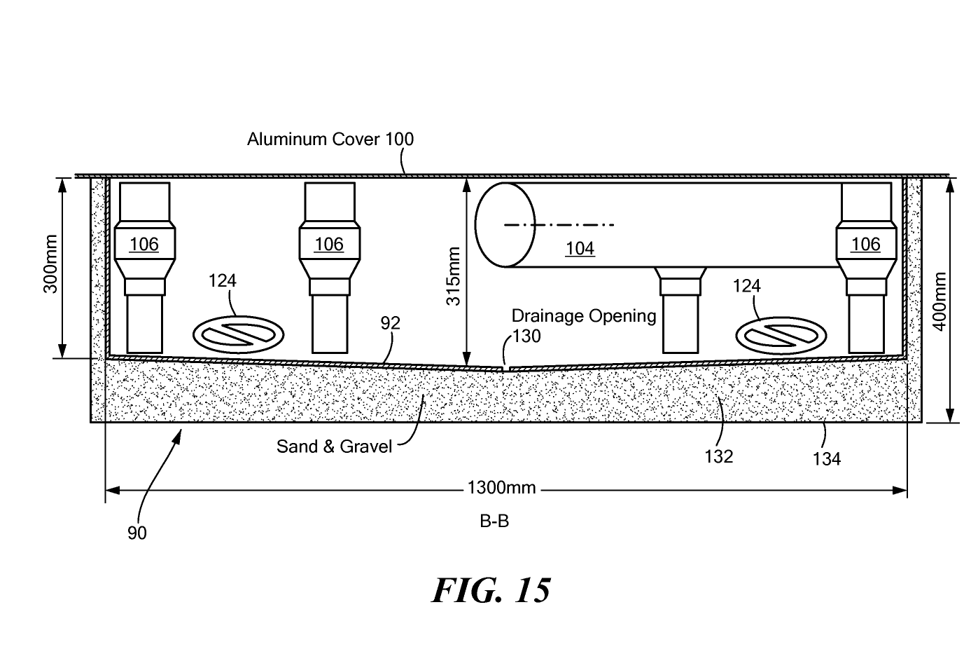

FIG. 15 illustrates in greater detail sectional and elevational view of the device 90 of the invention showing the contents of the detection device within box 92. Fans 124 are typically provided for cooling the contents of the box 92 in operation. Where the aluminum cover 100 is perforated, air can easily circulate for cooling purposes. The box 92 has a lower portion with a drainage opening 130 centered therein at a low point into a region 132 of gravel within a ditch 134 for supporting the detection system.

### APPENDIX A

Atometry is a bomb inspection process as described in the following articles:
B. Maglich et al. (1999). Proc. ONDCP International Technology Symposium, p. 9-37. “Demo of Chemically-Specific Non-Intrusive Detection of Cocaine Simulant by Fast Neutron Atometry.” Session A3b-Nonintrusive Inspection Test and Evaluation. (Office of National Drug Policy) Counterdrug Technology Assessment Center, Gov. Doc. NCJ-176972 [www.whitehousedrugpolicy.gov]. http://www.calseco.com/_docs/_released-docs/Demo_detection_of_cocaine_stimulant_by_fast_neutron.pdf;
B. C. Maglich, T.-F. Chuang, M. Y. Lee, C. W. Kamin and C. Druey. (2003). “SuperSenzor′ for Non-invasive Humanitarian Demining.” Session 8—Bulk Explosives Detection, Paper 262. http://www.eudem.vub.ac.be/eudem2-scot/
B. C. Maglich, T.-F. Chuang, M. Y. Lee, C. Druey and G. Kamim. (2003). “MiniSenzor′ for Humanitarian Noninvasive Chemical Identification of UXO Fillers.”, Session 8—Bulk Explosive Detection, Paper 255 (website for both 2 and 3): http://www.eudem.vub.ac.be/eudem2-scot/
B. C. Maglich. (2005). “Birth of ‘Atometry’—Particle Physics Applied To Saving Human Lives”, American Institute of Physics Conf. Proc.—Oct. 26, 2005—Volume 796, pp. 431-438; LOW ENERGY ANTIPROTON PHYSICS: Eighth International Conference on Low Energy Antiproton Physics (LEAP '05): DOI:10.1063/1.2130207 http://www.fz-juelich.de/leap05/en/ http://link.aip.org/link/?APCPCS/796/431/1

What is claimed is:

1. A method for detecting explosives in a vehicle comprising:
positioning a vehicle trunk over an explosive detection system;
emitting neutrons from said detection system into the trunk of said vehicle from position where the neutrons enter the trunk to any contents thereof;
detecting gamma rays emitted by any contents of the trunk;
analyzing the detected gamma rays for an indication of explosives in the contents.

2. The method of claim 1 wherein the analysis provides an indication of the amount of nitrogen in the contents.

3. The method of claim 1 wherein said analysis provides an indication of the amount of nitrogen, carbon and oxygen in the contents.

4. The method of claim 1 wherein the analysis provides an initial determination of a possibility of explosives in the contents.

5. The method of claim 4 wherein the analysis provides a more detailed evaluation of the gamma rays in response to the initial determination of a possibility of explosives to provide a higher reliability determination of the presence of explosives.

6. The method of claim 5 wherein the initial determination is based only on the presence of nitrogen, while the more detailed evaluation searches for the presence of nitrogen, carbon and oxygen.

7. The method of claim 1 wherein the neutrons are fast neutron.

8. The method of claim 1 wherein the neutrons are directed to penetrate a fuel tank in the trunk, whereby thermal neutrons are generated and are distributed through the trunk where they become absorbed by the nucleus of any nitrogen in the contents resulting in gamma ray generation that is detected.

9. The method of claim 1 wherein the results of the analysis are displayed for operator viewing in a form indicating the amount of nitrogen with or without carbon and oxygen.

10. The method of claim 9 wherein the results of the analysis provide a go/no-go indication of the likelihood of a presence of an explosive in the contents.

11. The method of claim 1 further including sensing gamma ray emission rate in said detecting step.

12. The method of claim 1 further including applying a two-step detection process comprising:
analyzing gamma rays for an indication of the presence of nitrogen in the contents and providing an indication of the possibility of an explosive in the contents;
if the indication of the possibility exceeds a predetermined value, analyzing the gamma rays for the presence of carbon and oxygen in addition to nitrogen to provide a highly reliable determination of the presence of an explosive.

13. The method of claim 12 wherein said highly reliable determination is correct within a few percent of 100 percent on average.

14. Apparatus for use in performing the method of claim 1 comprising:
a neutron, preferably fast neutron, emitter;
a plurality of gamma ray detectors;
means for shielding the emitter and detectors.

15. The apparatus of claim 14 further including a speed bump having a compartment including;
the emitter;
the plurality of detectors; and
space for said shielding means between the emitter and detectors.

16. The apparatus of claim 14 including electrons for activating the emitter and for providing signals representative of the level of detected gamma rays.

17. The apparatus of claim 14 further including means for displaying the presence and level of nitrogen represented by detected gamma rays.

18. The apparatus of claim 14 further including means for displaying the presence and level of carbon and oxygen represented by the detected gamma rays.

19. The apparatus of claim 14 further including means for generating an alarm based on information in the detected gamma rays that provides for the vehicle to remain in place for further gamma ray detection.

20. The apparatus of claim 19 wherein the alarm is generated based on the detection of a level of nitrogen.

21. Apparatus placeable on a drivable surface for sensing explosives in the trunk of a vehicle comprising:
a first chamber having a neutron emitter;
a second chamber having a plurality of means for sensing gamma rays created by an interaction of the emitted neutrons with contents of the trunk;
means for shielding neutrons from the emitter from the sensing means in a location between the first and second chambers.

22. The apparatus of claim 21 in the form of a speed bump.

23. The apparatus of claim 21 further comprising means for encouraging said vehicle trunk to remain over said sensing apparatus for a period of time sufficient for sensing the presence of explosives on said trunk.

24. The apparatus of claim 23 comprising a further speed bump located on the drivable surface at a location just beyond the sensing apparatus sufficient to stably locate the trunk above the sensing apparatus.

25. The apparatus of claim 21 comprising means for allowing the sensing apparatus to be mobile over said surface.

26. The method of claim 1 wherein said positioning step further includes the step of halting said vehicle by means of one or both of a speed bump and movable barrier.

27. The apparatus of claim 14 further including means for halting said vehicle by means of one or both of a speed bump and movable barrier.

28. A method for detecting explosives in a vehicle comprising:
a vehicle trunk over an explosive detection system;
emitting neutrons from said detection system into the trunk of said vehicle from a position where the neutrons enter the trunk to any contents thereof;
detecting gamma rays emitted by any contents of the trunk;
analyzing the detected gamma rays for an indication of explosives in the contents;
wherein the analysis provides an indication of the amount of nitrogen in the contents;
wherein said analysis provides an indication of the amount of nitrogen, carbon and oxygen in the contents;
wherein the analysis provides an initial determination of a possibility of explosives in the contents;
wherein the analysis provides a more detailed evaluation of the gamma rays in response to the initial determination of a possibility of explosives to provide a higher reliability determination of the presence of explosives;
wherein the initial determination is based only on the presence of nitrogen, while the more detailed evaluation searches for the presence of nitrogen, carbon and oxygen;
wherein the neutrons are fast neutron and are directed to penetrate a fuel tank in the trunk, whereby thermal neutrons are generated and are distributed through the trunk where they become absorbed by the nucleus of any nitrogen in the contents resulting in gamma ray generation that is detected;
wherein the results of the analysis are displayed for operator viewing in a form indicating the amount of nitrogen with or without carbon and oxygen;
wherein the results of the analysis provide a go/no-go indication of the likelihood of a presence of an explosive in the contents;
further including sensing gamma ray emission rate in said detecting step;
further including applying a two-step detection process comprising:
analyzing gamma rays for an indication of the presence of nitrogen in the contents and providing an indication of the possibility of an explosive in the contents;
if the indication of the possibility exceeds a predetermined value, analyzing the gamma rays for the presence of carbon and oxygen in addition to nitrogen to provide a highly reliable determination of the presence of an explosive;
wherein said highly reliable determination is correct within a few percent of 100 percent on average.
